(19) United States
(12) Patent Application Publication
(10) Pub. No.: US 2010/0276507 A1
(43) Pub. Date: Nov. 4, 2010

(54) APPARATUS AND METHOD FOR VARYING THE PROPERTIES OF A MULTIPLE-PHASE JET

(75) Inventors: Bernard Labegorre, Paris (FR); Thierry Poinsot, Plaisance Du Touch (FR); Nicolas Guezennec, Toulouse (FR)

Correspondence Address: AIR LIQUIDE USA LLC;Intellectual Property, 2700 POST OAK BOULEVARD, SUITE 1800, HOUSTON, TX, 77056, US

(73) Assignee: L'Air Liquide Societe Anonyme Pour L'Elude Et L'Ex ploitation Des Procedes Georges Claude, Paris (FR)

(21) Appl. No.: 12/812,412

(22) PCT Filed: Jan. 9, 2009
(86) PCT No.: PCT/FR09/50033

§ 371 Date: Jul. 9, 2010

(30) Foreign Application Priority Data
Jan. 10, 2008 (FR) 0850145

(51) Int. Cl. B05B 7/08

(52) U.S. Cl. 239/11; 239/433; 239/553

(57) ABSTRACT

The invention relates to an apparatus and a method for injecting a multiple-phase jet with a variable direction and/or opening, by the fluidic interaction between the multiple-phase jet and one or more actuation jets.

The present invention relates to an apparatus and a method for varying the properties of a multiphasic jet without interrupting said jet, and to applications thereof. The invention relates more specifically to an apparatus and a method for varying the direction and/or the spread of a multiphasic jet, said apparatus also, in the case of a multiphasic jet containing a dispersion of liquid particles, allowing the particle size of the liquid particles to be varied.

### Context of the Invention

Numerous industrial applications or methods employ sprayed liquids or pulverized or pulverulent solids in the form of gaseous jets containing a dispersion of said liquids and/or solids, known hereinafter as multiphasic jets.

This is the case, for example, of combustion methods or technologies that use finely dispersed liquid or solid fuels, or alternatively of freezing methods that employ sprayed jets of liquid nitrogen to cool foodstuffs. In both instances, the characteristics of the multiphasic jets determine the performance of the method (including: length of flame and heat transfer in one case, and speed and uniformity of cooling in the other).

It would often be beneficial to be able to modify the direction and/or the spread and, in particular, the direction and/or the spread, of a multiphasic jet in the enclosed space in which the method is taking place without the need to interrupt the method. For example, it would be beneficial to be able to incline a jet that results from the atomizing of a liquid fuel such as heavy diesel oil, or from the injection of pulverized coal so as to be able, during operation, temporarily to orient the flame toward the charge when there is a desire to increase its transfer of heat to the latter, or to be able to change the orientation of the resultant jet in order to avoid hotspots.

Several solutions for modifying the orientation of a multiphasic jet have been proposed.

Conventionally, variable-orientation diphasic jets are created using a spray device the orientation of which is varied or alternatively using a spray device that has at least one injection nozzle the orientation of which is varied. However, the mechanical systems for varying the orientation of a diphasic jet suffer from problems of reliability and durability, particularly in hostile environments such as combustion furnaces and cryogenic installations.

So-called non-mechanical systems for varying the direction of a diphasic jet have also been proposed.

EP-A-0545357 describes such an atomizer able to orient the direction of a diphasic jet resulting from the atomization of a liquid or pulverulent atomizable material using an annular jet of atomizing gas. According to EP-A-0545357, a fluidic control gas is injected into the annular jet upstream of the atomizing zone, so as to force the atomizing gas to pass through a part of the delivery cross section opposite the injection of the fluidic control gas and thus generate an asymmetric diphasic jet the axis of which is inclined with respect to the axis of the annular jet. This technology allows the inclination of the diphasic jet about the axis of the injector to be modified from to 20°. However, this technology has the major disadvantage of non-uniform spraying of the atomizable material in the deviated resultant jet, spraying being defective notably on the same side as the point at which the fluidic control gas is injected.

WO-A-9744618 also discloses a burner comprising a burner block, said burner block being provided with a central fuel duct surrounded by a plurality of primary oxidant ducts, themselves surrounded by a plurality of secondary oxidant ducts, it being possible for the fuel to be a liquid fuel atomized in some of the oxidant or alternatively, a crushed solid fuel carried along by some of the oxidant. By taking a greater or lesser amount of the primary oxidant from the secondary oxidant, the position and shape of the flame can be varied. The maximum flame deflection is limited to about 15° from the middle possible to the extreme position (namely at most 30° in total). In addition, the design of this burner is relatively cumbersome because the fuel duct, the plurality of primary oxidant ducts and the plurality of secondary oxidant ducts are created in a burner block which opens onto the combustion chamber of the furnace. Burner blocks are generally made of refractory materials that are somewhat difficult to manufacture, particularly in the case of small-sized systems.

### OBJECT OF THE INVENTION

It is an object of the present invention to provide a robust and optimized apparatus that allows a wide variation in the direction and/or the spread of a multiphasic jet without the need to interrupt the jet.

### DESCRIPTION OF THE INVENTION

In this context, what is meant by “multiphasic jet” is a dispersion of liquid in gas, a dispersion of solid in gas or alternatively a dispersion of liquid and solid in gas, progressing in a predominant direction in space. What is meant by “diphasic jet” is a dispersion of liquid in gas or dispersion of solid in gas, progressing in a predominant direction in space.

The “spread” of a jet denotes, for a jet opening out from a duct, the angle measured from the axis of symmetry of the jet or of the flame where it leaves the duct to the generatix at the surface of the jet. In practice, this angle often corresponds to the angle between the longitudinal axis of symmetry of the duct and the generatrix at the surface of the jet.

The orientation or direction of a jet is defined as being a vector normal to the passage cross section for the fluid and oriented in the direction of the flow, that is to say from the upstream direction downstream.

The present invention relates more particularly to an apparatus for injecting a variable-direction and/or variable-spread multiphasic jet. According to the invention, the apparatus comprises a spray device, also known as an atomizer, having a principal opening for injecting a multiphasic jet with a controlled or regulated momentum. The principal opening has a cross section Sp and is situated in a principal plane. The direction of the multiphasic jet emanating from the principal opening is known as the principal direction.

The apparatus also comprises a nozzle, also known as a mouthpiece, into which the principal opening of the spray device opens. This nozzle has an outlet opening for the multiphasic jet, this outlet opening being situated in an outlet plane and on the opposite side (in the principal direction) to the principal opening, so that the multiphasic jet emanating from the principal opening (also known as the “principal jet”), passes through the nozzle before leaving the nozzle via the outlet opening.

The apparatus also comprises at least one passage having a secondary opening for injecting into the nozzle a gaseous actuating jet that has a controlled or regulated momentum. The at least one passage is positioned in such a way that the actuating jet emanating from the corresponding secondary opening impinges on the multiphasic jet 1 inside the nozzle.

The direction of the actuating jet leaving the secondary opening is known as the secondary direction. This secondary direction makes, with the plane perpendicular to the principal direction, an angle θ, this angle θ being less than 90° and greater than or equal to 0°, preferably 0°≦θ≦80°, more preferably 0°≦θ≦30°, the effect of the actuating jet being at its most pronounced when θ is substantially equal to 0°, that is to say when the secondary direction of the actuating jet lies in a plane perpendicular to the principal direction of the multiphasic jet leaving the principal opening of the spray device. When θ is not equal to 0°, the direction of the corresponding actuating jet has a component in the principal direction extending in the direction from the principal opening toward the outlet opening.

As will be explained in greater detail hereinafter, the apparatus makes it possible to vary the direction and/or the spread of the multiphasic jet leaving the outlet opening by virtue of the interaction, and more particularly of the impingement, of the multiphasic jet emanating from the spray device with one or more actuating jets, without the need to interrupt the multiphasic jet and without the need to resort to mechanical actuators such as pivots.

The “Proceedings of FEDSM'02 Joint US ASME-European Fluid Engineering Division Summer Meeting of Jul. 14-18, 2002” and the article “Experimental and numerical investigations of jet active control for combustion applications” by V. Faivre and Th. Poinsot, Journal of Turbulence, Volume 5, No. 1, March 2004, page 24 disclose the use of a special configuration of four secondary jets around a gaseous monophasic jet in order to stabilize a flame through interaction between the secondary jets and the primary jet. A wider exit spread angle is observed.

The secondary opening or openings have their central point or center of inertia situated at a distance L1 away from the principal plane in which the principal opening of the spray nozzle is situated and at a distance L2 away from the outlet plane in which the outlet opening of the nozzle is situated. L1 and L2 are preferably less than or equal to ten times the square root of the cross section Ss of the secondary opening. The central point or center of inertia of a secondary opening corresponds to the intersection between the secondary opening and the axis of the actuating jet emanating from said secondary opening (corresponding actuating jet), or alternatively to the intersection between this outlet opening and the axis of the corresponding passage (that is to say the passage having this secondary opening) at this secondary opening. When the secondary opening is in the shape of a circle, its central point is the center of the circle. The distances L1 and L2 are measured parallel to the principal direction.

The nozzle is preferably made of metal.

The nozzle may be manufactured/machined as an integral part of the spray device. A more practical way of producing the nozzle is to manufacture/machine it separately and then mount it on the spray device as described hereinabove. The nozzle may more particularly have the form of an insert or of an end-piece mounted on the end of the spray nozzle comprising the principal opening thereof.

Typically, the internal cross section of the nozzle at the secondary opening or openings is perpendicular to the principal direction and greater than or equal to the cross section Sp of the principal opening of the spray device.

The spray device may be a spray device of the gas-assisted type. In such a case, the spray device typically comprises a central duct for supplying the liquid or powder that is to be sprayed and an annular duct surrounding the central duct for supplying the atomizing gas. At the outlet opening of the spray device, a multiphasic jet is created by the entrainment of the liquid or powder emanating from the central duct by the jet of atomizing gas emanating from the annular duct.

The spray device may be a mechanical spray device. If it is, the spray device typically comprises a central duct for supplying liquid, in which duct the pressure of the fluid is converted into kinetic energy. The high speed of the liquid jet leaving the spraying section will entrain some surrounding gas in sufficient quantity to generate a diphasic jet. The dimensions of the principal cross section of a mechanical spray device are typically one order of magnitude smaller than those of an assisted spray device for the same flow rate of fluid to be atomized.

The spray device may be an emulsion spray device. If it is, then the spray device typically comprises a central duct opening in the principal plane for injecting a dispersion of liquid in gas or pulverized solid in gas. The multiphasic jet is generated inside the spray device by suitably bringing a liquid flow and a gaseous flow into contact with one another. The dimensions of the principal cross section of an emulsion spray device are typically of the same order of magnitude as those of an assisted spray device for the same flow rate of liquid to be atomized.

The spray device may be hybrid, combining the concepts of assisted and emulsion spray devices.

Advantageously, the ratio between the square root of the cross section of the principal opening and the square root of the cross section of the secondary opening is greater than or equal to 0.25 and less than or equal to 10.0 (0.25≦√Sp/√Ss≦10.0), preferably greater than or equal to 1 and less than or equal to 10.

When the spray device is a spray device of the gas-assisted type, the emulsion type or the hybrid type, the ratio between the square root of the cross section of the principal opening and the square root of the secondary cross section is greater than or equal to 1 and less than or equal to 10, preferably greater than or equal to 3 and less than or equal to 7. When the spray device is a mechanical spray device this same ratio is preferably greater than or equal to 0.25 and less than or equal to 4.

According to one embodiment of the apparatus according to the invention that more particularly allows the injection of a variable-orientation multiphasic jet, the apparatus comprises at least one passage such that the secondary direction of the actuating jet emanating from the corresponding secondary opening is secant or near-secant to the principal direction of the principal jet emanating from the principal opening. In such a case, impingement between this actuating jet and the principal jet emanating from the principal opening will yield a multiphasic jet at the outlet of the outlet opening (of the nozzle) which is deviated with respect to the principal direction of the multiphasic jet at the outlet of the principal opening (of the spray device), the multiphasic jet emanating from the outlet opening being more particularly deviated in the direction away from the secondary opening of the actuating jet. An actuating jet emanating from an outlet opening to the left of the principal direction will thus give rise to a multiphasic jet at the outlet of the outlet opening that is deviated to the right with respect to the principal direction.

Just one actuating jet the secondary direction of which is secant or near-secant to the principal direction is thus able to vary the direction of the multiphasic jet in one direction (mono-directional effect).

A multi-directional effect (in which the direction of the multiphasic jet is varied in several directions) can be obtained with several actuating jets the secondary direction of which is secant or near-secant to the principal direction.

According to one embodiment, the apparatus comprises at least two passages such that the secondary directions of the actuating jets emanating from the corresponding secondary openings are secant or near-secant to the principal direction of the principal jet emanating from the principal opening, said secondary openings preferably being situated in one and the same plane perpendicular to the principal direction or, in other words, at one and the same distance L1 from the principal plane in which the principal opening of the spray device is situated.

When these two corresponding secondary openings are situated one on either side of the axis of the primary jet, it is possible to deviate the multiphasic jet at the outlet of the outlet opening in two opposite directions with respect to the principal direction, for example to deviate to the left using an actuating jet emanating from a secondary opening situated to the right of the principal direction and to deviate to the right using an actuating jet emanating from a secondary opening situated to the left of the principal direction.

When, on the other hand, the plane defined by the direction of one of the two secondary openings and the principal direction does not coincide with the plane defined by the other direction of the two secondary openings and the principal direction, it is possible to deviate the multiphasic jet in these two planes, or even in a plane somewhere between the two planes if the two actuating jets are injected simultaneously. For preference, the plane defined by one of the two secondary openings and the principal direction will be perpendicular to the plane defined by the other of the two secondary openings and the principal direction.

A very wide variation in the direction of the multiphasic jet leaving the outlet opening with respect to the principal direction can be achieved using four secondary openings around the principal direction. In such a case, the apparatus may notably comprise four passages positioned in such a way that the secondary directions of the actuating jets emanating from the corresponding secondary openings are secant or near-secant to the principal direction, two of these corresponding secondary openings defining a first plane with the principal direction and being situated on either side of this principal direction, the other two corresponding secondary openings defining a second plane with the principal direction and likewise being situated one on either side of this principal direction, the first plane preferably being perpendicular to the second plane and the four corresponding secondary openings preferably being situated in one and the same plane perpendicular to the principal direction (at one and the same distance L1 from the principal plane in which the principal opening of the spray device lies).

According to one embodiment of the apparatus according to the invention that allows the injection of a variable-spread multiphasic jet, the apparatus comprises at least one passage such that the secondary direction of the actuating jet emanating from the corresponding secondary opening is not substantially coplanar with the principal direction of the principal jet emanating from the principal opening. In such a case, interaction or impingement inside the nozzle between the actuating jet and the multiphasic jet leads to a multiphasic jet emanating from the outlet opening the spread of which jet is greater than the spread of the multiphasic jet that would be obtained in the absence of the actuating jet.

This effect of widening the spread of the final multiphasic jet is enhanced when use is made of several actuating jets the secondary direction of which is not coplanar with the principal direction and which are oriented in one and the same direction of rotation about the principal direction.

Thus, the apparatus according to the invention may comprise at least two passages oriented in such a way that the secondary directions of the actuating jets emanating from the corresponding secondary openings are not substantially coplanar with the principal direction of the principal jet emanating from the principal opening and that the secondary jets emanating from the corresponding secondary openings are oriented in one and the same direction of rotation about the principal direction. These corresponding secondary openings advantageously lie in one and the same plane perpendicular to the principal direction (at one and the same distance L1 away from the principal plane in which the principal opening of the spray device lies). They may be situated one on either side of the principal direction. They may equally be situated such that the plane defined by the principal direction and one of the two corresponding secondary openings is perpendicular to the plane defined by the principal direction and the other of the two corresponding secondary openings.

An apparatus which is particularly effective in varying the spread of a multiphasic jet is obtained when the apparatus comprises three or four secondary openings around the principal direction. Such an apparatus may notably comprise three or four passages positioned in such a way that the three or four corresponding secondary openings lie in one and the same plane perpendicular to the principal direction and that the secondary directions of the actuating jets emanating from the corresponding secondary openings are not substantially coplanar with the principal direction, the three or four actuating jets emanating from the corresponding secondary openings being oriented in one and the same direction of orientation about the principal direction.

The present invention also relates to the use of an apparatus according to the invention to vary the orientation and/or the spread of a multiphasic jet.

Thus, the invention relates more specifically to a method for modifying the orientation and/or the spread of a multiphasic jet by means of an apparatus according to one of the embodiments described hereinabove, and in which:
the multiphasic jet is injected into the nozzle through the principal opening of the spray device, said multiphasic jet being injected in a principal direction and with a regulated momentum,
at least one actuating jet is injected into the nozzle through the secondary opening of a passage, each actuating jet being injected with a regulated momentum and in a secondary direction such that the secondary jet impinges on the multiphasic jet inside the nozzle.

The secondary direction of each actuating jet makes, with the plane perpendicular to the principal direction, an angle θ, this angle θ being less than 90° and greater than or equal to 0°, preferably 0°≦θ≦80° and more preferably 0°≦θ≦30°, the effect that the actuating jet has on the multiphasic jet being at its most pronounced when the angle θ is substantially equal to 0° (the actuating jet is substantially perpendicular to the principal direction).

According to the method of the invention, the orientation and/or the spread of the multiphasic jet leaving the outlet opening of the nozzle is varied by varying the regulated momentum of at least one actuating jet.

As mentioned hereinabove, the method according to the invention allows the orientation of a multiphasic jet to be modified by injecting at least one actuating jet into the nozzle at a secondary orientation that is secant or near-secant to the principal direction of the multiphasic jet emanating from the principal opening. The spread of the multiphasic jet leaving the outlet opening of the nozzle is varied by varying the regulated momentum of the at least one actuating jet the secondary direction of which is secant or near-secant to the principal direction.

The deviation of the multiphasic jet with respect to the principal direction in the secondary direction increases with the momentum of the actuating jet (with respect to the momentum of the multiphasic jet emanating from the principle opening). In the absence of an actuating jet (actuating jet momentum=0), the direction of the multiphasic jet emanating from the outlet opening of the nozzle will be substantially identical to the principal direction (the direction of the multiphasic jet emanating from the principal opening of the spray device).

Various embodiments (numbers of actuating jets, position of the corresponding secondary openings, etc) of the method according to the invention for varying the orientation of the multiphasic jet have already been described hereinabove in relation to the corresponding apparatus.

In general, the physical parameter that governs the deviation of the multiphasic jet will be the ratio of the momentums of the actuating jet or jets and of the diphasic jet generated by the atomizer. This parameter may, in practice, be used to control or regulate the orientation of the multiphasic jet emanating from the outlet opening by fitting controls which regulate the momentums, and more particularly the flow rates, of the atomizing gas and of the actuating jet or jets.

As mentioned hereinabove, the method according to the invention makes it possible to modify the spread of a multiphasic jet by injecting at least one actuating jet into the nozzle the secondary direction of which is not substantially coplanar with the principal direction of the principal jet emanating from the principal opening. In such a case, the spread of the multiphasic jet leaving the outlet opening of the nozzle can be varied by varying the regulated momentum of the at least one actuating jet the secondary direction of which is not substantially coplanar with the principal direction.

The spread of the multiphasic jet emanating from the outlet opening increases with the momentum of the actuating jet.

As already mentioned hereinabove, a more pronounced increase in the spread of the final multiphasic jet can be obtained by injecting several actuating jets into the nozzle the secondary direction of which is not substantially coplanar with the principal direction of the principal jet emanating from the principal opening when these actuating jets are oriented in one and the same direction of rotation about the principal direction.

Various embodiments (numbers of actuating jets, position of corresponding secondary openings, etc.) of the method according to the invention for varying the spread of a multiphasic jet have already been described hereinabove in relation to the corresponding apparatus.

The physical parameter that controls the deviation of the multiphasic jet will generally be the ratio of the momentums of the actuating jet or jets and of the diphasic jet generated by the atomizer. This parameter may, in practice, be used to control or regulate the spread of the multiphasic jet emanating from the outlet opening using a control installation which regulates the momentums, and in general the flow rates more particularly, of the atomizing gas and of the actuating jet or jets.

In practice, the momentum of an actuating jet is more usually varied by regulating the flow rate of said actuating jet.

When it is desirable for the chemical composition and, in particular, the gas content of the multiphasic jet emanating from the outlet opening not to change when the orientation and/or spread thereof is/are varied, it is possible to provide the apparatus with a regulated overall gas supply and with a gas tapping to tap a fraction of said overall gas supply off to one or more passages for injecting one or more actuating jets. In such a case, the momentum of an actuating jet is varied by varying the fraction of the overall supply that is diverted to the corresponding passage. Such an embodiment of the apparatus and of the method may prove particularly advantageous when the multiphasic jet contains a mixture of fuel and oxidant.

The multiphasic jet may be a diphasic jet and, more particular, a liquid/gas diphasic jet or a solid/gas diphasic jet.

According to one useful application of the invention, the multiphasic jet contains a dispersion of liquid nitrogen.

According to another useful application of the invention, the multiphasic jet comprises a dispersion of a liquid fuel and/or of a solid fuel. In such cases it is often advantageous when the multiphasic jet is a dispersion in a gaseous oxidant. When the multiphasic jet contains a gaseous oxidant, this oxidant may be air.

However, when the gaseous phase of the multiphasic jet is an oxidant, this oxidant may, in certain cases, also have an oxygen content of at least 40 vol %, preferably at least 50 vol % and more preferably still, at least 90 vol %.

The method according to the invention makes it possible to modify the volume occupied by the dispersion and the speed of the particles. In the case of a liquid dispersion, the invention also makes it possible to alter the particle size distribution of the liquid particles.

The invention notably makes it possible for the orientation of the multiphasic jet to be varied linearly with the control parameter: the ratio of the momentum of the multiphasic jet injected into the nozzle and the momentum of the injected actuating jet.

The option of varying the orientation or the spread of a multiphasic jet in the absence of any mechanical movement of the injection apparatus or of the nozzle of said apparatus is a considerable advantage because in the industrial environments in which the integrity of such mechanisms is difficult to maintain over time because of the often hostile conditions such as very low or very high temperatures and/or high levels of dust or corrosive substances.

### [Part 3]

### EXAMPLES

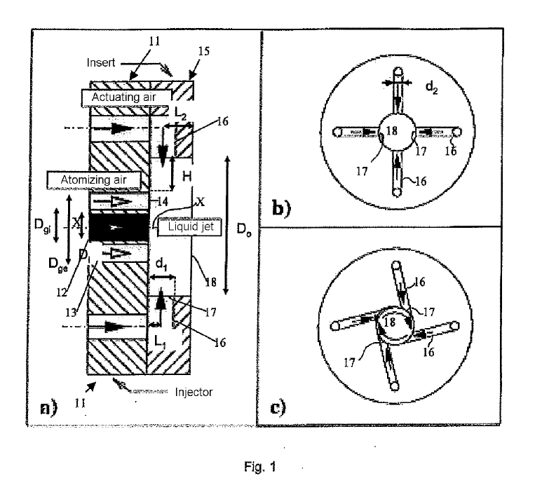

The invention will be better understood with the aid of the following exemplary embodiments, given by way of nonlimiting example, in conjunction with FIGS. 1 to 7.

FIGS. 1a, b and c schematically depicting two embodiments of an apparatus according to the invention, FIG. 1a depicting a longitudinal section through the apparatus and FIG. 1b depicting a cross section through the nozzle for varying the orientation of a multiphasic jet, and FIG. 1c depicting a cross section through the nozzle for varying the spread of a multiphasic jet.

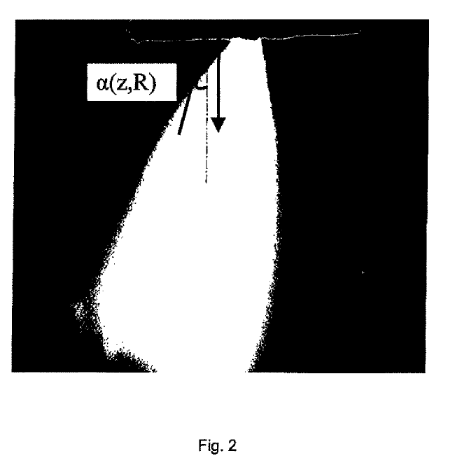

FIG. 2 depicting a view of a diphasic jet that has been deviated by means of an apparatus according to the invention,

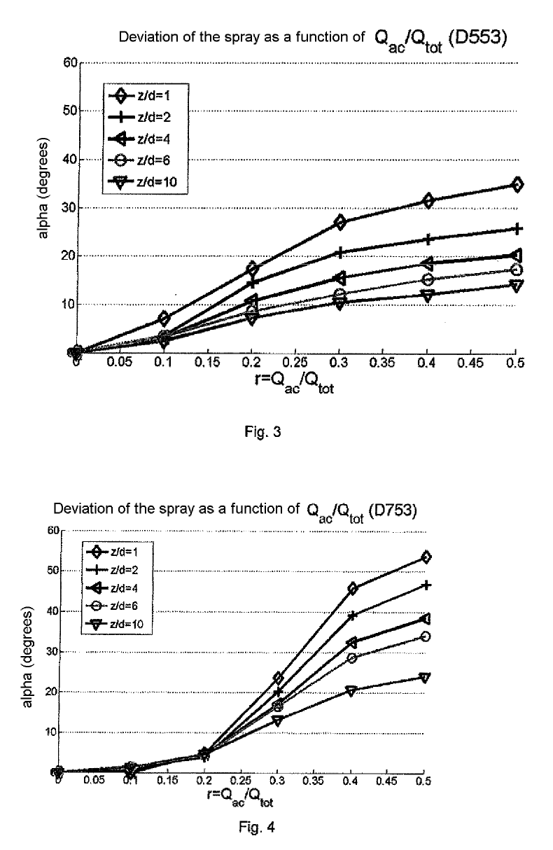

FIGS. 3 and 4 showing the impact of the ratio between the flow rate of the actuating jet and the flow rate of the jet an atomizing gas on the deviation of the multiphasic jet leaving the apparatus,

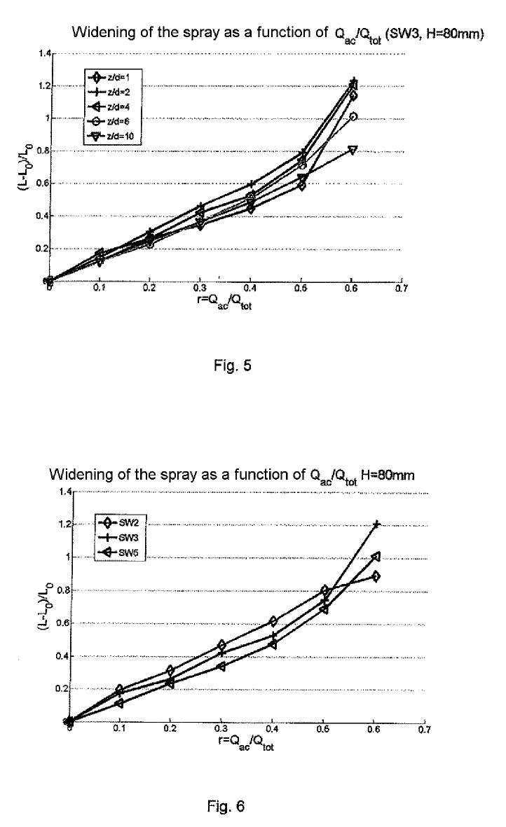

FIGS. 5 and 6 showing the impact that the ratio between the flow rate of the actuating jet and the flow rate of the atomizing gas jet has on the degree of widening of the multiphasic jet leaving the apparatus,

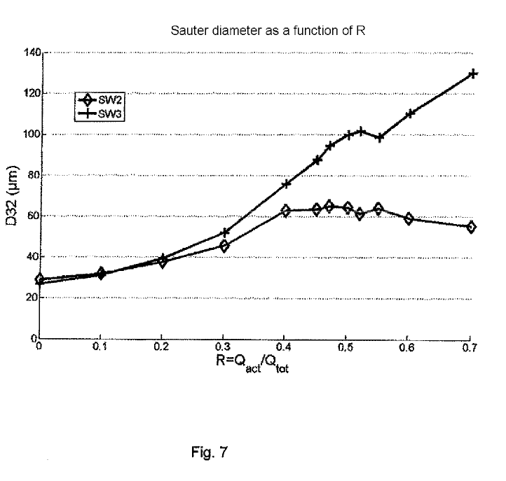

FIG. 7 showing the impact of the ratio between the flow rate of the actuating jet and the flow rate of the jet of atomizing gas on the mean particle size of the liquid particles in the multiphasic jet.

The invention uses gaseous jets, known as actuating jets, to control the direction (orientation) and/or the spread of a multiphasic jet produced by a spray device, often known as an atomizer in the case of a liquid/gas multiphasic jet.

FIG. 1 shows an apparatus according to the invention comprising an atomizer of the gas-assisted type 11 and a nozzle 15.

The atomizer 11 comprises a central duct 12 for supplying the liquid that is to be sprayed and an annular duct 13 surrounding the central duct 12 and for supplying atomizing gas. The central duct 12 and the annular duct 13 open into the principal opening 14 of the atomizer 11. Thus, a liquid jet is injected at the center of the principal opening 14 and is surrounded in this principal opening by an annular gaseous atomizing jet. The kinetic energy of the high-speed annular jet atomizes the liquid jet in order, downstream of the principal opening 14, to obtain a liquid/gas diphasic jet in a principal direction X-X, the liquid/gas dispersion appearing right at the outlet of the atomizer.

The typical size of the liquid droplets in the diphasic jet is of the order of a few tens of microns.

According to the invention, the apparatus comprises passages 16 for the injection of gaseous actuating jets. The secondary openings 17 corresponding to said passages 16 are situated in the nozzle 15 downstream of the principal opening 13 of the atomizer 11. These secondary openings 17 are situated in a plane perpendicular to the principal axis X-X of the diphasic jet (the plane of FIGS. 1b and 1c respectively).

There are two different arrangements of the passages and corresponding secondary openings illustrated for a four actuating jet configuration.

FIG. 1b shows a radial layout of the actuating jets, that is to say that, in this figure, the passages 16 and the secondary openings 17 are positioned in such a way that the actuating jets emanating from the secondary openings 17 have a secondary direction (denoted by arrows) which are secant to the principal direction X-X of the diphasic jet. This embodiment of the invention enables the direction of the multiphasic jet leaving the outlet opening 18 of the nozzle 15 to be varied.

FIG. 1c shows a tangential layout of the actuating jets emanating from the secondary openings 17. In this figure, the passages 16 and the secondary openings 17 are positioned in such a way that the secondary directions (denoted by straight arrows) of the actuating jets emanating from the secondary openings 17 are not coplanar with the principal direction X-X but are all oriented in one and the same direction of rotation (denoted by the two curved arrows) about the principal direction. When one or more actuating jets impinges on the multiphasic jet inside the nozzle, this results in a widening of the spread of the diphasic jet emanating from the outlet opening 18.

The following dimensions are marked on FIG. 1:

Dimensions of the Coaxial Atomizer:

D₁: Diameter of the central duct for supplying liquid
D_{gi}: Internal diameter of the annular atomizing-gas duct
D_{ge}: External diameter of the annular atomizing-gas duct

Dimensions of the Control System:

Dₒ: Diameter of the outlet opening of the apparatus
H: Distance between the outlet openings and the principal opening measured at right angles to the principal direction X-X
d₁: 1^{st} characteristic dimension of the passage
d₂: 2^{nd} characteristic dimension of the passage
d=√(d₁²+d₂²)
L₁: Distance between the central point of the secondary opening and the principal plane
L₂: Distance between the central point of the axis of the secondary opening and the outlet plane.

Typically, the distances L1 and L2 measured parallel to the principal direction X-X between the central point of the secondary opening 17 and, respectively, the plane of the principal opening 13 and the plane of the outlet opening 18, are between one and ten times the square root of the cross section of the secondary opening 17. The square root of the cross section of the secondary opening 17 corresponds to the cross section of the actuating jet at this secondary opening. The square root of the cross section of the secondary opening 17/of the cross section of the actuating jet at the outlet of this secondary opening 17 is known hereinafter as the characteristic dimension d of the actuating jet.

The characteristic dimension of the actuating jets determines, for a given fluid flow rate in the corresponding passage 16, the momentum of the actuating jets.

In order to achieve significant deviations in the orientation of the multiphasic jet (see FIG. 1b), the desire will be to maximize the ratio between the momentum of the actuating jet or jets injected into the nozzle 15 and the momentum of the multiphasic jet leaving the principal opening 13, bearing in mind the fact that, in practice, the characteristic dimensions of the passages are generally subject to manufacturing constraints.

The number of secondary jets acting on one multiphasic jet will typically be limited to four, in as much as a greater number of secondary jets will not significantly improve the performance of the apparatus and of the method but could lead to construction difficulties and higher manufacturing costs. Furthermore, because the actuators are positioned in a zone close to the principal opening 13 and to the outlet opening 18 this, for space reasons, limits the number of them.

The examples hereinbelow relate to the use of the apparatus and of the method according to the invention for varying the orientation or the spread of a multiphasic jet.

The apparatus for varying the orientation of a multiphasic jet (examples 1 to 3) is essentially as illustrated in FIGS. 1a and 1b, just one actuating jet that has a secondary direction secant to the principal direction being injected into the nozzle.

The apparatus for varying the spread of a multiphasic jet (examples 4 to 6) is essentially as illustrated in FIGS. 1a and 1c, with four actuating jets injected.

In FIGS. 3 to 6, z is the distance downstream of the outlet opening of the apparatus (measured in the principal direction) at which the deviation alpha (α) and the widening (L-L₀)/L₀ are respectively measured. A measurement at z=0 is therefore a measurement directly at the outlet of the outlet opening, L₀ being the width of the multiphasic jet at z=0, that is to say at the outlet opening.

### Control Parameter

The operating parameter for the apparatus and method according to the invention is, in the examples (for constant actuating jet characteristic dimensions), the ratio of the flow rates of gas passing respectively through the passage or passages as actuating jets and through the annular atomizing jet.

For all the results set out in this document, the total flow rate of gas through the actuators and the atomizing jet has remained constant.

### Deviation of the Multiphasic Jet

### Examples 1 to 3

### Deviation of the Multiphasic Jet

### Example 1

The deviation of the multiphasic jet is defined as the angle between the direction of the multiphasic jet leaving the outlet opening 18 of the nozzle and the principal direction X-X of the multiphasic jet leaving the principal opening of the atomizer.

This angle can be measured from the envelope of the multiphasic jet at the outlet of the control chamber using ombroscopy (see FIG. 2).

FIG. 2 shows a mean and processed image of a diphasic jet or “spray” of water generated by an atomizer of the air-assisted type subjected to the action of an actuating jet by means of the apparatus in order to vary the orientation of the multiphasic jet. The injection conditions for this example are: water flow rate of the order of 6 g/s, gas flow rate in the annular atomizing jet of the order of 1.3 g/s, and gas flow rate in the actuator of 0.7 g/s. The observed angle through which the diphasic jet is deviated is around 30°.

### Example 2

FIG. 3 shows the impact of the control parameter on the deviation of the diphasic jet in the apparatus for varying the direction of the multiphasic jet (FIGS. 1a and b) in which Dₒ=7.5 mm and d₁=3.0 mm.

It will be noted first of all in this figure that the angle of deviation of the liquid jet decreases with increasing distance away from the injector. This result could be explained by the ballistics of the liquid droplets subjected to the effects of gravity (the injector being positioned here in a downwards vertical position).

It will be noted especially that the angle of deviation of the diphasic jet increases substantially linearly with the control parameter. This phenomenon demonstrates a high dynamic range (great amplitude in the level of control and in the angle through which the jet can be deviated) and the control parameter therefore provides good control over the direction of the multiphasic jet using a control installation that regulates the momentums or flow rates of the respective gaseous jets.

In addition, the maximum value obtained for this first configuration is greater than the one obtained with the known non-mechanical systems, for example that of EP-A-0545357.

### Example 3

FIG. 4 shows the impact of the control parameter on the deviation of the diphasic jet in the apparatus for varying the direction of a multiphasic jet (FIGS. 1a and b) with the same dimensions and operating conditions as in FIG. 3, except that Dₒ=5.5 mm here. The secondary opening of the actuator jet is therefore in this case not as far away from the principal opening (lower value of H).

This figure shows a thresholding effect followed by a very great increase in the angle of deviation of the jet with the level of control. Furthermore, the maximum amplitude of the deviation is far greater than in the previous case.

It is thus possible to adjust the amplitude of the deviation of the jet and the dynamic range of the control system (the ratio between the control parameter and the deviation of the jet obtained) through a suitable choice of the distance H.

In order to obtain very great amplitudes, for example of as much as 50° or 60°, use will be made of a distance H ranging between 0.5 and 1.50 times the characteristic dimension d of the actuating jet. By contrast, if only a substantial deviation (30°) with no thresholding effect (substantially linear relationship between the control parameter and the deviation of the jet obtained) is desired, then a distance of between 0 and 0.2×d will be chosen.

### Examples 4 and 5

### Spread of the Diphasic Jet

The spread of the multiphasic jet emanating from the outlet opening is defined on the basis of the envelope of the diphasic jet, this envelope being determined as mentioned hereinabove. In practice, a level of widening of the jet is determined as being the relative variation in the width of the diphasic jet at a given distance downstream of the injector.

### Example 4

FIG. 5 shows the change in the level of widening of the “spray” as a function of the control parameter for four actuating jets laid out tangentially with H=80 mm and d₁=3 mm. A continuous and linear evolution up to a control parameter=5, likewise exhibiting a very high dynamic range, can be seen.

### Example 5

As shown in FIG. 6, for actuators positioned tangentially, the diameter d₁ of the passage and, therefore, for the same d₂, also the dimension d of the passage, do not appreciably modify the effect of the control. In this figure, SW2, SW3 and SW5 differ in that in SW2: d₁=2 mm, in SW3: d₁=3 mm and in SW5: d₁=5 mm.

### Example 6

### Particle Size Distribution in the Diphasic Jet

While the actuating jets allow the direction of a diphasic jet or the spread thereof to be modified as has already been seen, they also allow the particle size distribution to be modified, that is to say they make it possible to alter the distribution of the sizes of the droplets. In this example 8, a Malvern optical technique (the scattering of light by the particles) is used to measure the mean size (the Sauter mean diameter).

FIG. 7 shows the change in mean Sauter diameter (D32) for four actuating jets set out tangentially. It can be seen that there is a continuous increase in mean Sauter diameter at a dimension d₁ (and therefore, at d₂ that is constant, at a dimension d that is greater. By contrast, when d₁ (and therefore, for a d₂ that is constant, d) is smaller, the increase in the size of the particles is rapidly limited. The choice of the dimensions of the passage and therefore of the secondary opening and, in consequence, of the cross section of the actuating jet at the outlet of the corresponding secondary opening, would, for example, allow the spray to be opened wider with or without any significant modification in the size of the particles.

1-16. (canceled)

17. An apparatus for injecting a variable-direction and/or variable-spread multiphasic jet, said apparatus comprising:
a spray device having a principal opening for injecting a regulated momentum multiphasic jet in a principal direction, said principal opening being situated in a principal plane and having a cross section Sp, and
a nozzle into which the principal opening of the spray device opens, said nozzle having an outlet opening for the multiphasic jet which opening is situated in an outlet plane and on the opposite side to the injection opening, and
at least one passage having a secondary opening for injecting into the nozzle an actuating jet of regulated momentum gas in a secondary direction so that the actuating jet impinges on the multiphasic jet inside the nozzle, said secondary opening having a cross section Ss, the second direction making, with the plane perpendicular to the principal direction, an angle θ less than 90° and greater than or equal to 0°, whereby the secondary opening of the at least one passage has a central point situated at a distance L1 away from the principal plane and at a distance L2 away from the outlet plane and whereby L1 and L2 are each ≦10×√Ss.

18. The apparatus of claim 17, wherein the nozzle is made of metal.

19. The apparatus of claim 17, wherein 0.25≦√Sp/√Ss≦10.0.

20. The apparatus of claim 17, said apparatus further comprising at least one passage such that the secondary direction of the actuating jet emanating from the corresponding secondary opening is secant or near-secant to the principal direction of the multiphasic jet emanating from the principal opening.

21. The apparatus of claim 20, further comprising at least two passages oriented in such a way that the secondary directions of the actuating jets emanating from the corresponding secondary openings are secant or near-secant to the principal direction of the multiphasic jet emanating from the principal opening.

22. The apparatus of claim 17, further comprising at least one passage such that the secondary direction of the actuating jet emanating from the corresponding secondary opening is not substantially coplanar with the principal direction of the principal jet emanating from the principal opening.

23. The apparatus of claim 22, further comprising at least two passages oriented in such a way that the secondary directions of the actuating jets emanating from the corresponding secondary openings are not substantially coplanar with the principal direction of the multiphasic jet emanating from the principal opening and that the secondary jets emanating from the corresponding secondary openings are oriented in one and the same direction of rotation about the principal direction.

24. The apparatus of claim 17, wherein the second direction makes, with the plane perpendicular to the principal direction, an angle θ less than or equal to 80° and greater than or equal to 0°.

25. The apparatus of claim 17, wherein the second direction makes, with the plane perpendicular to the principal direction, an angle θ less than or equal to 30° and greater than or equal to 0°.

26. A method for modifying the orientation and/or the spread of a multiphasic jet with the apparatus of claim 17, comprising the steps of:
injecting the multiphasic jet with the spray device into the nozzle through the principal opening of the spray device, said multiphasic jet being injected in a principal direction and with a regulated momentum;
injecting at least one actuating jet into the nozzle through the secondary opening of a passage, each actuating jet being injected with a regulated momentum and in a secondary direction such that the secondary jet impinges on the multiphasic jet inside the nozzle, the secondary direction making, with the plane perpendicular to the principal direction, an angle θ less than 90° and greater than or equal to 0; and
varying the orientation and/or the spread of the multiphasic jet leaving the outlet opening of the nozzle by varying the regulated momentum of at least one actuating jet.

27. The method of claim 26, in which method the secondary orientation of at least one actuating jet injected into the nozzle is secant or near-secant to the principal direction of the multiphasic jet emanating from the principal opening, and the spread of the multiphasic jet leaving the outlet opening of the nozzle is varied by varying the regulated momentum of the at least one actuating jet the secondary direction of which is secant or near-secant to the principal direction.

28. The method of claim 26, in which method the secondary orientation of at least one actuating jet injected into the nozzle is not substantially coplanar with the principal direction of the multiphasic jet emanating from the principal opening, and in which the spread of the multiphasic jet leaving the outlet opening of the nozzle is varied by varying the regulated momentum of the at least one actuating jet the secondary direction of which is not substantially coplanar with the principal direction.

29. The method of claim 26, in which the multiphasic jet is a liquid/gas diphasic jet or a solid/gas diphasic jet.

30. The method of claim 26, in which the multiphasic jet contains a dispersion of liquid nitrogen.

31. The method of claim 26, in which the multiphasic jet comprises a dispersion of a liquid fuel and/or of a solid fuel.

32. The method of claim 29, in which the multiphasic jet is a dispersion in a gaseous oxidant.

33. The method of claim 32, in which the gaseous oxidant has an oxygen content of at least 40 vol %, preferably at least 50 vol % and more preferably still, at least 90 vol %.

34. The method of claim 26, wherein the secondary direction makes, with the plane perpendicular to the principal direction, an angle θ less than or equal to 80° and greater than or equal to 0°.

35. The method of claim 26, wherein the secondary direction makes, with the plane perpendicular to the principal direction, an angle θ less than or equal to 30° and greater than or equal to 0°.

36. The method of claim 30, in which the gaseous oxidant has an oxygen content of at least 50 vol %.

37. The method of claim 30, in which the gaseous oxidant has an oxygen content of at least 90 vol %.
